(19) United States
(12) Patent Application Publication
(10) Pub. No.: US 2018/0291637 A1
(43) Pub. Date: Oct. 11, 2018

(54) SLIP-RESISTANT, SELF ILLUMINATED FRONT LIT ARTICLE

(71) Applicant: 3M INNOVATIVE PROPERTIES COMPANY, St. Paul, MN (US)

(72) Inventors: John C. Schultz, Afton, MN (US); Erik A. Aho, New Richmond, WI (US); John E. Gozum, Stillwater, MN (US); Michael J. Sykora, New Richmond, WI (US)

(21) Appl. No.: 15/765,335

(22) PCT Filed: Sep. 30, 2016
(86) PCT No.: PCT/US2016/054599

§ 371 Date: Apr. 2, 2018

Related U.S. Application Data
(60) Provisional application No. 62/237,608, filed on Oct. 6, 2015.

(51) Int. Cl. E04F 15/02; E04F 15/10; G09F 19/22

(52) U.S. Cl. CPC E04F 15/02172; E04F 11/17; G09F 19/228; E04F 15/107

(57) ABSTRACT

Light transmissive non-slip treads coupled to a light directing film having a structured surface for redirecting light oriented on a first axis. The non-slip treads may appear to be specifically illuminated, as if by dedicated light fixtures, but may instead be illuminated by ordinary ambient light.

### BACKGROUND

Slip resistant tapes and treads are frequently placed on slip-prone surfaces, in order to improve safety and reduce the incidence of slip and fall-type accidents. Slip resistant tapes and treads typically include adhesive-backed tapes or sheets, with a rough mineral-based or textured polymer upper surface. They may be placed, for example, on stair treads or wet areas, to decrease the incidence of a person slipping. As such, they can have an important role in residential and workplace safety. One such anti-slip product line is sold by 3M Company of St. Paul, Minn., under the Safety-Walk label. The products sold under the label feature several options of adhesive-backed anti-slip sheeting, including opaque and semi-clear, as well as different roughnesses, including fine, medium, and course.

### SUMMARY

Slip resistant tapes and treads are coupled with front-lit, ambient light illuminated sheeting. In some locations, this combination results in higher visual conspicuity for the tread. Particularly, in normal lighting conditions, without any lights dedicated to the tread, the tread may appear to be lit, as if by one or more dedicated and focused front lights. This improved visual conspicuity may be particularly well suited for applications where it is helpful for a person to notice that a non-slip tread has been placed in a particular area. A graphics layer may also be present, allowing the slip resistant tread to convey a message to persons in the area (for example, “DANGER” or “CAUTION” and/or commercial advertising content).

### BRIEF DESCRIPTION OF DRAWINGS

The accompanying drawings are incorporated in and constitute a part of this specification and, together with the description, explain the advantages and principles of the invention. In the drawings,

FIG. 1 is a picture of a walkway featuring a stairway at its end;

FIG. 2 is a profile view of an ambient light illuminated slip-resistant sheet;

FIG. 3 is a side sectional view of ambient light illuminated layer;

FIG. 4 is a diagram illustrating ray tracing for the signage of FIG. 3;

FIG. 5 is a plan view of an example ambient light illuminated slip-resistant sheet;

FIG. 6 is a plan view of an example ambient light illuminated slip-resistant sheet;

FIG. 7 is a plan view of an example ambient light illuminated slip-resistant sheet;

FIG. 8 is a plan view of an example ambient light illuminated slip-resistant sheet; and,

FIG. 9 is a plan view of an example ambient light illuminated slip-resistant sheet.

### DETAILED DESCRIPTION

It has been discovered that combining front lit, “self-illuminated” sheeting with slip resistant adhesive-backed sheeting may provide for greater visual saliency of the slip resistant sheeting, thus improving the chance a person will notice it, and thereby potentially improving overall safety of the person, by reducing the chance of slip and fall-type accidents.

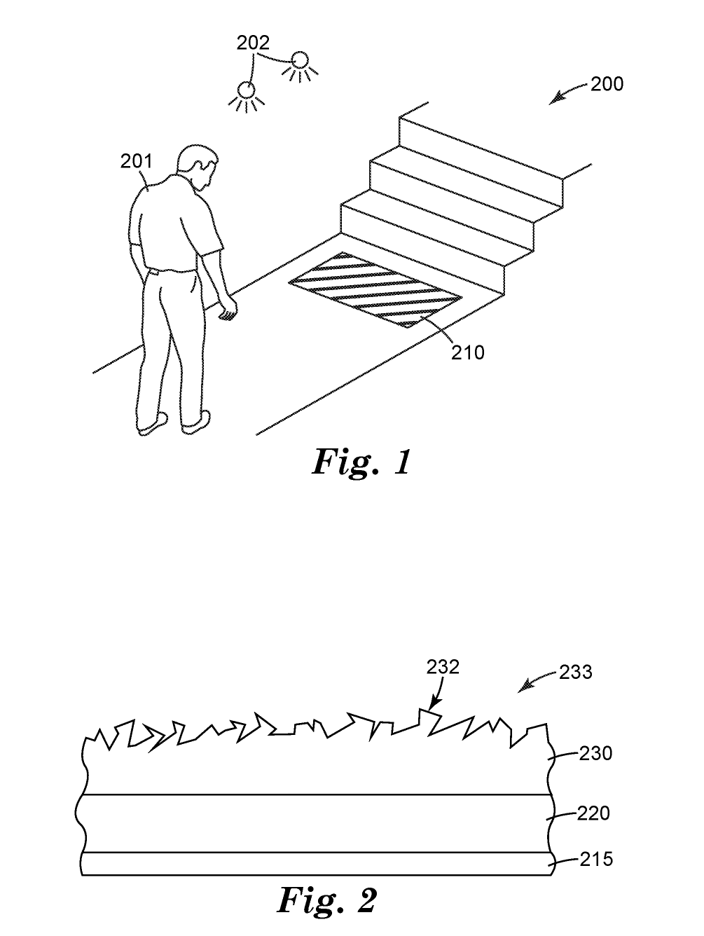

FIG. 1 is a drawing of what such a combination may look like in one embodiment. In scene 200, person 201 is seen walking along a walkway, approaching a series of steps. Featured prominently in the path of person 201 is an ambient light illuminated slip-resistant sheet 210. Lights 202 are ordinary lights as would be used to illuminate a passage such as that shown; they could be point sources of light such as incandescent or sodium, or they could be long narrow fluorescent fixtures, or some combination of directed or diffuse lighting technology. Lights 202 providing this ambient light are preferably pre-existing so that additional power and light fixtures are not required. Though sheet 210 has no particular lights directed specifically on it, from the perspective of person 201, it may appear as if as if it does. This causes person 201 to take greater notice of the area, and sheet 210 in particular. Sheet 210 has a rough top surface, with a static coefficient of friction of at least 0.5, reducing the chance of person 201 slipping when he or she steps on sheet 210. Though shown as placed before the first step in scene 200, in practice sheet 210 may be placed on each stair tread, or wherever desired to reduce the chance of slippage by persons. While the example shown has sheet 210 under the general illumination of multiple lights 202, other locations are possible. It is also possible to rotate sheet 210 to achieve illumination effect. Sheet 210 is referred to as “ambient light illuminated” (and such language is used elsewhere in this disclosure), but it is within the scope of this disclosure to specifically illuminate the sheeting also. “Ambient light illuminated” is meant to label an object being referred to, and should not be read as limiting the sheet to only ambient light.

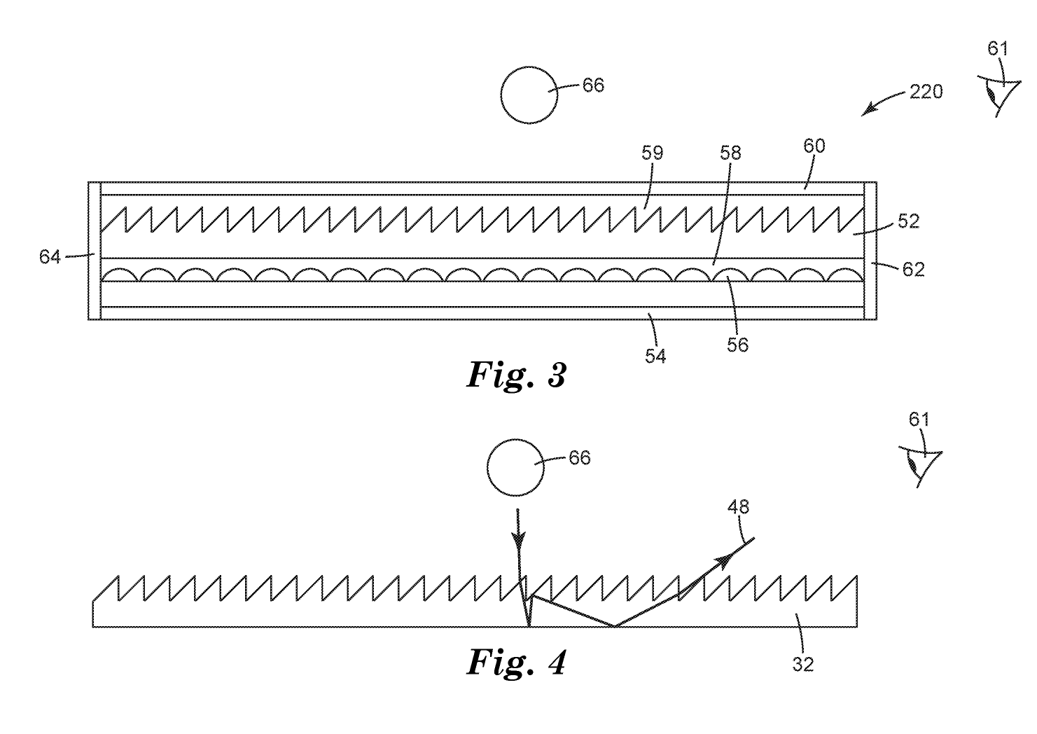

FIG. 2 shows film stack 233, which is a profile rendering of sheet 210. Slip resistant layer 230, which typically comprises abrasive particles, comprises the uppermost layer of the stack. The upper surface of slip resistant layer 230 is rough, having a static coefficient of friction of at least 0.4, and more ideally at least 0.6. Slip resistant layer 230 may include opaque areas or contain one or more light transmissive areas, depending on the materials used and the safety or advertising pattern desired. For example, abrasive mineral particles usually equates to slip resistant layer 230 being opaque, whereas the use of aluminum oxide particles embedded in a clear or semi-clear ionomer may result in a light transmissive slip-resistant layer 230. In one embodiment, particles of 48 grit aluminum oxide are disposed in a layer of Surlyn® brand ionomer resin, sold by the DuPont Company of Wilmington, Del., thus providing a light transmissive substrate. Such an embodiment is sold by 3M Company of St. Paul, Minn. under its Safety-Walk™ brand, under the product name “220 Clear”. Slip resistant surface 252 may include an index matching coating, such as a UV cured acrylate resin or other coatings known in the art, which further enhances the light transmission of slip resistant layer 230, which may be helpful in certain embodiments, described further herein, where graphic layers below the slip resistant layer are meant to be seen by nearby persons. U.S. Pat. No. 6,024,824, “Method of Making Articles in Sheet Form, Particularly Abrasive Articles” describes methods of making non-slip articles that may produce adhesive layers that could be used as slip resistant layer 230, by passing particles through a thermal sprayer, such as a flame sprayer having a nozzle emitting a flame. Other methods of making a slip resistant layer 230 are known in the art.

Coupled to slip resistant layer 230 is ambient light illuminated layer 220. Ambient light illuminated layer 220 is described below, but generally includes, from top to bottom, a graphic layer, a light turning film comprising an array of light directing features, and a reflector. Other intervening layers could also be included. The bottom surface of ambient light illuminated layer 220 interfaces with adhesive layer 215, which would then in turn couples to an installation surface, such as a stair tread, concrete floor, etc. Stack 233 may be provided on a release liner (not shown in FIG. 2) for convenient application.

A side sectional view of ambient light illuminated layer 220 is shown in FIG. 3. Layer 220 includes a turning film 52, a reflector 54, a diffuser 56, and a graphic 60. Layer 220 can also include an optional air gap 58 between turning film 52 and diffuser 56, and an optional air gap 59 between turning film 52 and graphic 60. An optional edge tape or frame 62 and 64 can be used around the edges of signage 50. The diffuser is placed behind the turning film (between the reflector and turning film) with graphic 60 remaining in front of the turning film from the viewer's perspective. In this construction, the diffuser can be attached to the turning film through lamination or a microreplication process with the back side of the diffuser metalized 54 to eliminate the need for a separate reflector. In use, turning film 52 directs light from a light source 66 to graphic 60 and a viewer 61 in order to passively illuminate the signage.

Turning film 52 can be implemented with a sawtooth prism film, for example, or other types of light redirecting films having a structured surface for redirecting light. For example, a linear Fresnel film can be used instead of a sawtooth prism film. Alternatively, a linear microsctructure with the non-sawtooth, “roof-like” prism angles may instead be used as the structured surface. Reflector 54 can be implemented with a specular reflector, for example the Enhanced Specular Reflector (ESR) film from 3M Company. In some cases the specular reflector may have regular or irregular structures so as to provide a controlled amount of angular spreading. Specular reflectors with structure include, for example, metalized microstructured films. In some cases the reflector can be semi-specular in nature where the reflector provides a small amount of spreading or limited amount of diffusion for light incident on the reflector. Semi-specular reflectors include, for example, a lightly diffuse coating on ESR film. The optional air gap 59 can help prevent damage to the prisms of turning film 52. The air gap also provides a refractive index difference. The edges of the construction may be sealed to prevent ingress of moisture or contaminants into the air gap. The sealing technique may be to use a tape, or an adhesive or even melting the layers together. Instead of an air gap, a material with a refractive index significantly different than the refractive index of the adjacent film layers may be used thereby producing an ambient light illuminated layer that does not have an air gap and hence may be more durable.

An optional diffusing film may be placed on top of graphic 60. Additionally, or taking the place of such a diffusing film, the light transmissive slip resistant layer 230 may act as a diffuser in certain embodiments.

In use, the light directing features (for example sawtooth prisms) in turning film 52 direct light from light source 66, such as a room light, to graphic 60 in order to passively illuminate the signage for a viewer 61. Ambient light illuminated layer 220, and others similar embodiments, are described in greater detail in association with FIG. 4 of U.S. Pat. No. 8,915,002 “Self Illuminated Signage for Printed Graphics”; US Pat. Application Publication No. 2014/525,882 “Self Illuminated Shaped and Two-sided Signage for Printed Graphics”; and US Pat. Application Publication No. 2015/068080 “Self Illuminated Signage for Printed Graphics”, each of which is incorporated by reference in its entirety herein. Methods for modifying the orientation of the turning film so as to achieve a good “ambient lighting” effect at install are further described in patent application No. 62/171,413.

FIG. 4 is a diagram illustrating ray tracing for the ambient light illuminated layer 220 of FIG. 3, represented by line 48 showing how turning film 32 directs light from room light 66 toward viewer 61, to create the effect of passive illumination. To viewer 61, a graphic layer situated above turning film layer 32 (as is shown in the embodiment shown in FIG. 3), may appear as if a dedicated light is shining on it, but it is actually illuminated using ambient or generalized light.

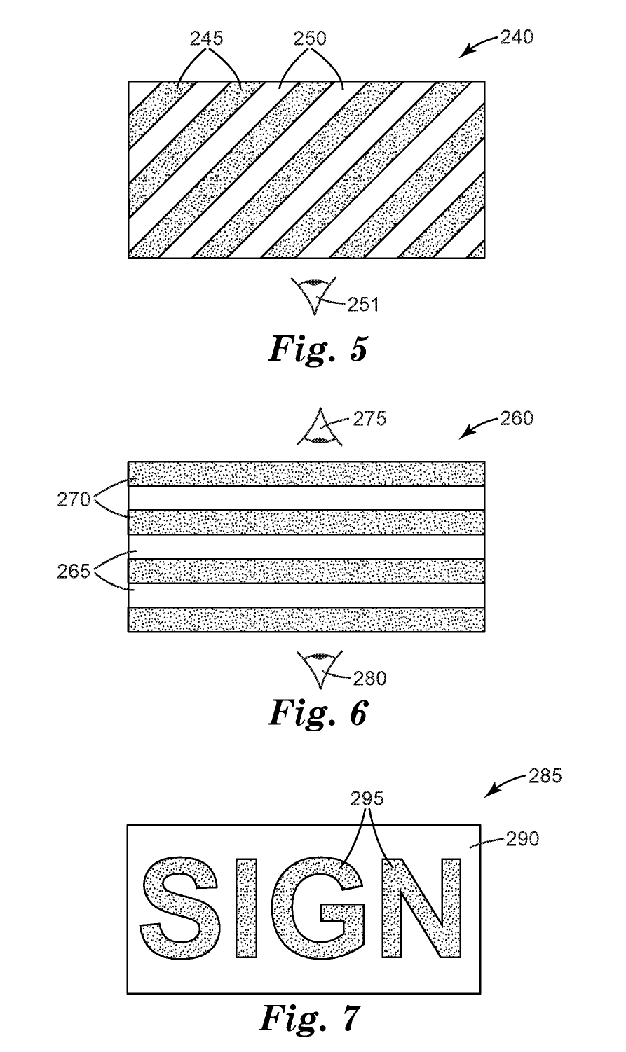

FIG. 5 is a plan view of one embodiment of ambient light illuminated slip-resistant sheet 240. The graphic layer of sheet 240 comprises diagonally oriented stripes. Stripes 245 could be dark, whereas stripes 250 could be, e.g., a high visibility color such as chartreuse. The entire upper surface could comprise a slip resistant layer that is light transmissive. The ambient light illuminated layer in sheet 240 is placed with light directing features oriented horizontally, such that if the sheet were adhered to, for example, a floor, overhead generalized lighting would cause sheet 240 to appear bright relative to the surrounding surface, e.g. the floor, and be noticed by observer 251, who is approaching from an angle approximately orthogonal to the direction of the sheet orientation.

FIG. 6 is a plan view of a further embodiment of ambient light illuminated slip-resistant sheet 260. In this embodiment, the ambient light illuminated layer includes more than one stripe with alternating orientations designed to provide the illumination effect toward two separate observers, each located orthogonal to either side of sheet 260. In particular, stripes 270 include an ambient light illuminated layer that provides its illumination-type effect toward observer 275, whereas stripes 265 include an ambient light illuminated layer that provides its illumination-type effect toward observer 265. In this way, a person approaching from either side of sheet 260 would more likely notice sheet 260, as it would appear to be illuminated as if by a dedicated light. A graphic layer may correspond to the striped pattern, as with different colors for example. While the illustration 240 and 260 show illumination-type effects in one or two directions, additional areas and orientations of the ambient light illuminated signage can produce visually bright portions of the sign from other directions, orthogonal to the orientation of the features and the light source.

The entire upper surface of sheet 240, sheet 260, etc. may comprise a light transmissive slip resistant layer, as described earlier, or striped portions may alternate between light transmissive slip resistant portions and opaque slip resistant portions. Of course, it is not necessary to have portions of ambient light illuminated layer underneath the opaque sections of the sheet which can provide additional adhesion area thereby improving the toughness and abrasion resistance of the signage.

FIG. 7 is a plan view of a further embodiment of ambient light illumined slip-resistant sheet 280, showing advertising content “SIGN” written in block letters on sheet 280. Area 290 may comprise a first color or graphical design, and include under it ambient light illuminated layer, whereas the block lettering 295 might be left opaque by using an opaque slip resistant layer, or by using a light transmissive layer but omitting the ambient light illuminating layer. Of course the block lettering may also simply be a different color than the surrounding area, and/or it may comprise letters having an ambient light illuminated layer with a different orientation, such that it “shines” best at different approach angles, increasing visual saliency.

FIG. 8 is a plan view of a further embodiment of ambient light illuminated slip-resistant sheet 300. In this embodiment, graphical areas 305 comprise a hexagonal design with six distinct areas having 6 different ambient light illuminated layer orientations. These graphical areas 305 allow the illumination-type feature to be present 360 degrees around sheet 300. This effect may be produced by cutting and orienting the ambient light illuminated layer by hand, or during the manufacturing process with a tool that creates the light directing features and the prism pattern. When installed, e.g., on a floor with suitable overhead light, observers 306, 307, and 308 would each see separate areas of graphical areas appear to be illuminated.

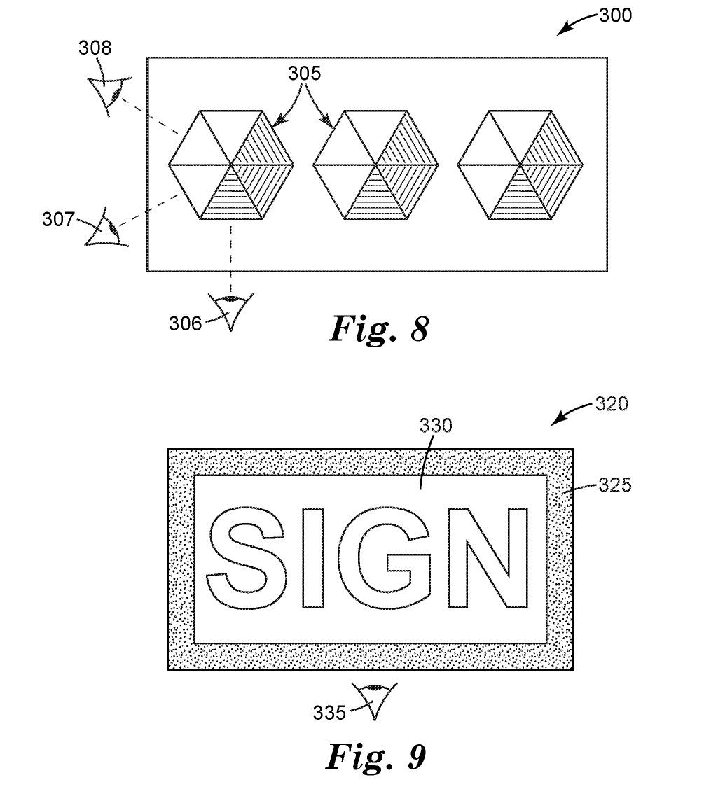

FIG. 9 is a plan view of a further embodiment of ambient light illuminated slip-resistant sheet 520. Perimeter area 225 includes an ambient light illuminated layer, but interior area 330 may or may not. The entire sheet 520 is covered, in one embodiment, with a light transmissive slip resistant layer. In another embodiment, the perimeter area 225 includes an opaque slip resistant layer, whereas the interior area 330 has the ambient light illuminated layer. As may be appreciated by these few examples, there are many further combinations of that are possible, limited largely by an artist or graphic designer's imagination.

### EXAMPLES

Ambient light illuminated slip resistant sheets with graphics were produced and luminance values measured. These examples are merely for illustrative purposes only and are not meant to be limiting on the scope of the appended claims

### Test Methods—Luminance Measurement

Samples were placed on the floor in a 10 foot tall room lit with ceiling mounted, fluorescent artificial light. Luminance measurements were made using a Minolta Luminance Meter LS-100 (available from Konica Minolta Sensing Singapore Pte Ltd). Luminance values are expressed in units of cd/m² (nits) and recorded in Table 1. Gain for the Examples 1 through 4 was calculated by dividing the luminance value of the Example by the luminance value of Comparative Example 1 and the results were recorded in Table 1.

All samples were printed using a Roland SP-300i eco-solvent printer (available from Roland USA).

### Comparative Example 1—Sample Construction White Vinyl Sign

A white vinyl sample 50.8 micron thick (white vinyl film #180C-151-010 available from 3M Company, St. Paul, Minn.) was printed using a Roland SP-300i printer. The printed pattern was a typical floor safety warning pattern with diagonal yellow and black stripes with an area of approximately 5×21 inches. The luminance of the yellow regions was used as the reference luminance for comparing the luminance of the various constructions noted below.

### Example 1—Sample Construction Bright SAFETY WALK

The bright SAFETY WALK demonstration was constructed using, in sequence from closest to the viewer to the floor, an oversized 620B SAFETY WALK layer, 3M ENVISION Matte 8550 Overlaminate (both available from 3M Company, St. Paul, Minn.), a 2 mil spacer layer of PET and an ambient light illuminated layer.

The oversized 620B SAFETY WALK material was cut roughly ½″ per edge larger than the printed sign dimensions. This extra width adhered the final sign the floor surface.

The 8550 overlaminate was printed on the non-adhesive side using a Roland SP300i printer. The print side was dried and then adhered to the SAFETY WALK adhesive, thereby protecting the printed image which was sandwiched in the SAFETY WALK adhesive.

The 2 mil layer of PET was adhered to the 8550 adhesive layer to ensure an airgap between the 8550 and the ambient light illuminated layer turning film.

The ambient light illuminated layer comprised sawtooth shaped features oriented as described in U.S. Pat. No. 8,915,002 “Self Illuminated Signage for Printed Graphics,” and as is seen in FIG. 4. The back side of the ambient light illuminated layer was coated with evaporated aluminum to provide a highly reflective surface.

The sign was then sealed to the floor by cleaning the floor with isopropyl alcohol to remove wax and then adhering the edges of the oversized SAFETY WALK material to the floor.

Yellow areas of the resulting construction were measured with the Minolta camera with the Bright SAFETY WALK sign located directly under an overhead fluorescent light in a comparable position to Comparative Example 1. Results are recorded in Table 1.

### Example 2—Sample Construction Bright Border

The Bright Border SAFETY WALK demonstration was constructed using, in sequence from closest to the viewer to the floor, an undersized 620B SAFETY WALK layer, an oversized 3M ENVISION Matte 8550 Overlaminate, both available from 3M Company, St. Paul, Minn.), a 2 mil spacer layer of undersized PET and an ambient light illuminated layer.

The undersized 620B SAFETY WALK material was cut roughly ½″ per edge smaller than the printed sign and ambient light illuminated layer dimensions. The oversized 8550 overlaminate was printed on the non-adhesive side using a Roland SP300i printer. The print side was dried and then centered on and adhered to the SAFETY WALK adhesive, thereby partially protecting the printed image which was sandwiched in the SAFETY WALK adhesive. The 2 mil layer of undersized PET was adhered to the center of the 8550 adhesive layer to ensure an airgap between the 8550 and the ambient light illuminated layer turning film but provide an adhesive layer from the 8550 around the edges of the film stack.

The ambient light illuminated layer comprised sawtooth shaped features oriented as described in U.S. Pat. No. 8,915,002 “Self Illuminated Signage for Printed Graphics” and as is seen in FIG. 4, was aligned to the 2 mil layer of undersized PET to maintain the airgap. The back side of the ambient light illuminated layer was coated with evaporated aluminum to provide a highly reflective surface.

The sign was then sealed to the floor by cleaning the floor with isopropyl alcohol to remove wax and then adhering the edges of the oversized 8550 overlaminate to the floor. Yellow areas of the resulting construction were measured with the Minolta camera with the Bright Border sign was located directly under an overhead fluorescent light in a comparable position to Comparative Example 1. Results are recorded in Table 1.

### Example 3—Sample Construction Patterned SAFETY WALK

The Patterned SAFETY WALK demonstration was constructed using, in sequence from closest to the viewer to the floor, stripes of 620B SAFETY WALK, a 3M ENVISION Matte 8550 Overlaminate layer (both available from 3M Company, St. Paul, Minn.), a 2 mil spacer layer of PET and an ambient light illuminated layer.

The 620B SAFETY WALK material was cut into diagonal stripes the same shape and size as the printed black portion of the diagonal yellow and black striped pattern. The strips of SAFETY WALK material were then adhered only to the printed black regions of the diagonal yellow and black striped pattern. The oversized 8550 overlaminate was printed on the non-adhesive side using a Roland SP300i printer leaving a clear border of nominally ½″ on all edges of the printed area. The print side was dried and then centered on and adhered to the SAFETY WALK adhesive with the SAFETY WALK strips aligned to the black stripes on the printed pattern. The 2 mil layer of PET was adhered to the center of the 8550 adhesive layer to ensure an airgap between the 8550 and the ambient light illuminated layer turning film but provide an adhesive layer from the 8550 around the edges of the film stack.

The ambient light illuminated layer comprised sawtooth shaped features oriented as described in U.S. Pat. No. 8,915,002 “Self Illuminated Signage for Printed Graphics” as per FIG. 4 and was aligned to the 2 mil layer of PET to maintain the airgap. The back side of the ambient light illuminated layer was coated with evaporated aluminum to provide a highly reflective surface. The sign was then sealed to the floor by cleaning the floor with isopropyl alcohol to remove wax and then adhering the edges of the oversized 8550 overlaminate to the floor. Yellow areas of the resulting construction were measured with the Minolta camera with the Patterned SAFETY WALK sign located directly under an overhead fluorescent light in a comparable position to Comparative Example 1. Results are recorded in Table 1.

### Example 4—Sample Construction Multiple Direction SAFETY WALK

The Multiple Direction SAFETY WALK demonstration was constructed as the Bright Border sample construction except the underlying ambient light illuminated layer was cut into two pieces and ½ was rotated 180 degrees. In this fashion, half the sign was bright for viewers approaching from one direction and half the sign was bright for viewers approaching from the opposite direction.

Yellow areas of the resulting construction were measured with the Minolta camera with the Multiple Direction SAFETY WALK sign was located directly under an overhead fluorescent light in a comparable position to Comparative Example 1. Results are recorded in Table 1.

### Measurement Data

The signs noted above were fabricated and the luminance measured on the yellow portion of all signs. The relative gain was calculated by dividing by the IJ180 yellow reference value (Comparative Example 1).

TABLE 1
Luminance and Gain

| Sample # | Luminance (cd/m²) | Gain |
|---|---|---|
| Comparative Example 1 - IJ180 reference | 203 | 1.0 |
| Example 1 - Bright | 217 | 1.1 |
| Example 2 - Bright Border | 834 | 4.1 |
| Example 3 - Patterned | 931 | 4.6 |
| Example 4 - Multiple Direction | 715 | 3.5 |

1. A slip-resistant, self-illuminated front lit adhesive backed article comprising:
a light transmissive friction layer, comprising an upper and lower major surfaces, wherein the upper major surface comprises a rough surface having static coefficient of friction of at least 0.50; and,
an ambient light illuminated layer having an upper major surface and a lower major surface comprising layers in the following order from upper to lower:
a graphic layer comprising a printed graphic;
a turning film layer having a first structured surface for redirecting light, and a second surface opposite the first surface, the first structured surface comprising a plurality of elongated, sawtooth shaped light directing features; and
a reflective layer comprising a reflector.

2. The article of claim 1, further comprising:
additional layers between the light transmissive friction layer and the ambient light illuminated layer.

3. The article of claim 1, further comprising:
additional layers between the layers that comprise the ambient light illuminated layer.

4. The article of claim 1, further comprising:
an air gap layer between the light transmissive friction layer and the ambient light illuminated layer.

5. The article of claim 1, wherein the lower major surface of the light transmissive friction layer is adhesively coupled to the upper major surface of the ambient light illuminated layer.

6. The article of claim 5, wherein the upper major surface has a static coefficient of friction of at least 0.60.

7. The article of claim 5, further comprising:
an adhesive layer having an upper and lower major surface, the upper major surface coupled to the lower major surface of the ambient light illuminated layer.

8. The article of claim 7, further comprising:
an release liner having an upper and lower major surfaces, the upper major surface comprising a silicone-based release layer, the upper major surface adhesively coupled to the lower major surface of the adhesive layer.

9. The article of claim 1, wherein the rough surface comprises a plurality of light transmissive particles having an average particle diameter of at least 500 μm.

10. The article of claim 9, wherein the rough surface comprises a plurality of light transmissive particles having an average particle diameter of at least 600 μm.

11. The article of claim 10, wherein the rough surface comprises a plurality of light transmissive particle having an average particle diameter of at least 700 μm.

12. The article of claim 1, wherein the turning film has an orientation, which is orthogonal to the direction of the sawtooth shaped light directing features.

13. The article of claim 1, wherein the graphic layer comprises photoluminescent material.

14. The article of claim 1, wherein the light-transmissive friction layer comprises an index-matching material applied to the upper major surface.

15. The article of claim 14, wherein the index-matching material comprises a UV cured acrylate resin.

16. The article of claim 1, wherein the article comprises a sheet.

17. The article of claim 1, wherein the article comprises a roll.

18. The article of claim 1, wherein the light transmissive friction layer has static coefficient of friction of at least 0.60.
